(19) United States
(12) Patent Application Publication
(10) Pub. No.: US 2026/0291587 A1
(43) Pub. Date: Sep. 24, 2026

(54) RADAR UTILIZATION OF COMMUNICATION SIGNALS IN A WIRELESS DEVICE

(71) Applicant: Telefonaktiebolaget LM Ericsson (publ), Stockholm (SE)

(72) Inventors: Rickard LJUNG, Helsingborg (SE); Henrik SJÖLAND, Lund (SE); Gang ZOU, Lund (SE); Magnus SANDGREN, Staffanstorp (SE); Andres REIAL, Höllviken (SE)

(21) Appl. No.: 19/473,516

(22) PCT Filed: Apr. 19, 2023
(86) PCT No.: PCT/EP2023/060182

§ 371 Date: Oct. 8, 2025

(51) Int. Cl. H04B 7/06; G01S 7/282; H04L 5/00

(52) U.S. Cl. CPC H04B 7/06952; G01S 7/282; H04L 5/0005

(57) ABSTRACT

A method and wireless device for radar utilization of communication signals in a wireless device (WD) are disclosed. According to one aspect, a method in a WD includes configuring a first set of spatial characteristics for a first transmit signal to be transmitted to the network node. The method also includes configuring a second set of spatial characteristics for a second transmit signal to be transmitted to the 5 network node, where the second transmit signal is adapted for communication and radar sensing. The method also includes transmitting the first and second transmit signals using time and frequency resources allocated by the network node for communication with the network node.

### TECHNICAL FIELD

The present disclosure relates to wireless communications, and in particular, to radar utilization of communication signals in a wireless device (WD).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP may also develop standards for Sixth Generation (6G) wireless communication networks.

This disclosure relates to mobile devices (also denoted as wireless devices (WDs) or user equipment (UE) in 3GPP standards) and spatial transmission characteristics of RF signals transmitted by the WD. Related requirements in 3GPP identifying transmit requirements may be relevant.

In 3GPP Technical Standard (TS) 38.101, related requirements are set forth:
Requirements on Maximum output power levels, e.g., absolute power levels.
Requirements on the WD to have a spherical coverage. This implies requirements on an ability to cover a full sphere over different beams. There are no requirements on how wide or narrow a separate beam shall be. The WD may adjust each beam as needed or desired; and
Beam correspondence: Beam correspondence is defined by 3GPP standards as the ability of the WD to select a suitable beam for uplink (UL) transmission based on downlink (DL) measurements with or without relying on UL beam sweeping. Hence, a WD may determine which spatial characteristics of UL signals are suitable for communication with a network node, based on measurements on DL signals.

Within cellular wireless communication systems the radio resources (time and frequency slot combinations—also called resource elements) are often controlled by central network nodes. As an example, in 3GPP systems such as LTE and NR, the radio resources for each cell are controlled by base stations, called eNB or gNB.

A wireless device may utilize allocated transmission resources for the assigned tasks by the base station, such as transmitting reference, control and/or data signals to one or more base stations (uplink transmissions) or to one or more other wireless device (sidelink transmissions). Resources may be allocated by the network for transmissions having different purposes, e.g., control channels may be transmitted with the purpose of evaluating radio channel properties, or for managing a radio resource configurations, or for radio signal based positioning functionality as supported by the standardized communication protocol. A promising future technology area for usage of radio resources in cellular wireless communication systems may also be for combined radar and communication purposes.

Solutions have been proffered as to how time and frequency resources may be multiplexed between radar and communication purposes and that beams and beam directions may be shared. Specifically, when there are two different directions (beams) for radar and communication, solutions have been presented for using one beam on one set of resources for radar and another beam using a different set of resources for communication.

However, solutions also exist for a combined transmission using the allocated uplink signals for radar transmissions.

The transmit resources in a wireless communication system may be used for various purposes such as data transmissions, control signaling, positioning or radar.

The allocated network resources may be coupled with properties determined by the WD to configure transmission parameters of the wireless device. Such properties may be the spatial characteristics of the transmission. The wireless device using network allocated signals for communication transmission may optimize the properties to be as suitable as possible for communication. However doing so may mean the transmissions become less than optimal for radar signaling. On the other hand, current solutions clearly do not allow optimizing the transmission for radar operation since, for example, directing the radiated energy in sensing-related directions may severely compromise the communication signal reception by the network node, e.g., gNB, and associated functionality.

### SUMMARY

There is a need for a signal transmission scheme in a WD that allows radar signal optimization without compromising simultaneous communication functionality. Embodiments described herein may advantageously provide methods in wireless devices for radar signal transmission.

In some embodiments, a wireless device is configured to use multiple time and frequency resources allocated by a network node for communication purposes. The device transmits communication signals over two subsets of the resources. In some embodiments, the WD uses the resources of the first set for communication signals. The WD uses the resources of the second set for communication and radar signal transmission.

The WD determines opportunities to adjust a signal on the second subset for improved radar operation and modifies one or more spatial transmission characteristics of the signal on this second subset. In particular, the device may control the direction of a subset of the total transmit energy of the signal for radar purposes separately from the direction of the transmit energy that is steered according to legacy principles. In some embodiments, both spatial subsets of transmit energy (targeting radar and communication) may transmit the communication components signal contents.

The effect of this modification of the transmission characteristics is that the WD may adjust the signal to better operate as a radar signal as compared to a legacy behavior for communication usage. The improvement may imply a better radar accuracy by, for example, constructing a beam lobe which emits a requisite amount of energy in the intended radar direction, or by adjusting the beamwidth of one or more sidelobes of the signal to achieve better angular granularity in the radar operation. In addition, for radar illumination in a spatial direction the modification may also be used to provide an over the air synchronization reference path between the transmit and receive node in a bistatic radar operation.

The communication purposes may include any of idle mode or active mode operations, meaning the resources used for communication and radar may include control signaling such as random access preamble transmissions, sounding reference signal (SRS) transmissions, positioning reference signal (PRS) transmissions such as sidelink positioning signals (SL-PRS), side link synchronization signals and/or control channel and data transmissions, for example.

In some embodiments, a WD is configured to perform both communication within a wireless network and radar operation using resources that are allocated for communication signaling. The WD may be configured to transmit communication signals as a sum of two spatial configurations using the communication resources on each of at least one subset of the first subset of resources and the second subset of resources. The WD may also use resources of second subset for radar transmission.

In some embodiments, the WD determines the opportunities to optimize the signal on the second subset for radar operation and modifies one or more spatial transmission characteristics of the signal on this second subset.

The WD may improve the radar operation compared to the legacy, i.e., known, behavior.

The control signaling for WD radar functionality may be kept to a minimum. Example implementations may be transparent to the network and may not require any additional signaling between a WD and network nodes such as a gNB or an eNB to manage the functionality.

Some embodiments may provide one or more of the following:
spectrum efficiency since radar transmissions does not need dedicated spectrum resource; and/or
energy efficiency since same parts in the TX chains are used for both communication and sensing simultaneously.

The modification of the beam shape may be performed by modifying the antenna weights in a polar domain and/or a cartesian domain, thus being applicable to both analog and digital beamforming transmitters.

According to one aspect, a WD configured to communicate with a network node is provided. The WD includes processing circuitry configured to: configure a first set of spatial characteristics for a first transmit signal to be transmitted to the network node and configure a second set of spatial characteristics for a second transmit signal to be transmitted to the network node, the second transmit signal being adapted for communication and radar sensing. The WD also includes a radio interface in communication with the processing circuitry and configured to transmit the first and second transmit signals using time and frequency resources allocated by the network node for communication with the network node.

According to this aspect, in some embodiments, the processing circuitry is further configured to configure a first subset of the time and frequency resources and a second subset of the time and frequency resources and the radio interface is further configured to: transmit to the network node on the first subset, the first transmit signal having the configured first set of spatial characteristics; and transmit to the network node on the second subset, the second transmit signal having the configured second set of spatial characteristics. In some embodiments, the processing circuitry is further configured to modify spatial characteristics of the second set of spatial characteristics to configure the second transmit signal for radar sensing. In some embodiments, spatial characteristics of the first set of spatial characteristics are determined prior to transmission of a sounding reference signal, SRS, and maintained until a next SRS transmission. In some embodiments, the processing circuitry is further configured to modify the second set of spatial characteristics while maintaining a communication beam with the first set of spatial characteristics during a sounding reference signal, SRS, period. In some embodiments, the first set of spatial characteristics are selected to provide a main lobe for communication signaling and a the second set of spatial characteristics are selected to provide a side lobe for radar sensing using communication signaling. In some embodiments, the radio interface includes a first antenna set configured to transmit the first transmit signal according to the first set of spatial characteristics and includes a second antenna set configured to transmit the second transmit signal according to the second set of spatial characteristics. In some embodiments, the radio interface is configured to transmit both the first transmit signal and the second transmit signal from a same antenna set. In some embodiments, the second set of spatial characteristics include a first set of beam forming weights for forming a radar beam and the first set of spatial characteristics include a second set of beam forming weights for forming a communication beam. In some embodiments, the processing circuitry is further configured to add the first set of beam forming weights and the second set of beam forming weights to produce a beam pattern for transmitting a radar signal on the radar beam and a communication signal on the communication beam, wherein the radar signal and the communication signal are the same transmission signal. In some embodiments, the radar beam and the communication beam are transmitted using a same set of time-frequency resources.

According to another aspect, a method in wireless device, WD, configured to communicate with a network node is provided. The method includes configuring a first set of spatial characteristics for a first transmit signal to be transmitted to the network node. The method includes configuring a second set of spatial characteristics for a second transmit signal to be transmitted to the network node, the second transmit signal being adapted for communication and radar sensing. The method also includes transmitting the first and second transmit signals using time and frequency resources allocated by the network node for communication with the network node.

According to this aspect, in some embodiments, the method also includes configuring a first subset of the time and frequency resources and a second subset of the time and frequency resources. In some embodiments, the method also includes transmitting to the network node on the first subset, the first transmit signal having the configured first set of spatial characteristics. In some embodiments, the method also includes transmitting to the network node on the second subset, the second transmit signal having the configured second set of spatial characteristics. In some embodiments, the method also includes modifying spatial characteristics of the second set of spatial characteristics to configure the second transmit signal for radar sensing. In some embodiments, spatial characteristics of the first set of spatial characteristics are determined prior to transmission of a sounding reference signal, SRS, and maintained until a next SRS transmission. In some embodiments, the method also includes modifying the second set of spatial characteristics while maintaining a communication beam with the first set of spatial characteristics during a sounding reference signal, SRS, period. In some embodiments, the first set of spatial characteristics are selected to provide a main lobe for communication signaling and a the second set of spatial characteristics are selected to provide a side lobe for radar sensing using the communication signaling. In some embodiments, the method also includes transmitting the first transmit signal according to the first set of spatial characteristics and includes a second antenna set configured to transmit the second transmit signal according to the second set of spatial characteristics. In some embodiments, the method includes transmitting both the first transmit signal and the second transmit signal from a same antenna set. In some embodiments, the second set of spatial characteristics include a first set of beam forming weights for forming a radar beam and the first set of spatial characteristics include a second set of beam forming weights for forming a communication beam. In some embodiments, the method includes adding the first set of beam forming weights and the second set of beam forming weights to produce a beam pattern for transmitting a radar signal on the radar beam and a communication signal on the communication beam, wherein the radar signal and the communication signal are the same transmission signal. In some embodiments, the radar beam and the communication beam are formed using a same set of time-frequency resources.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a WD over an at least partially wireless connection according to some embodiments of the present disclosure;

FIG. 3 is a flowchart illustrating example methods implemented in a communication system including a host computer, a network node and a WD for executing a client application at a WD according to some embodiments of the present disclosure;

FIG. 4 is a flowchart illustrating example methods implemented in a communication system including a host computer, a network node and a WD for receiving user data at a WD according to some embodiments of the present disclosure;

FIG. 5 is a flowchart illustrating example methods implemented in a communication system including a host computer, a network node and a WD for receiving user data from the WD at a host computer according to some embodiments of the present disclosure;

FIG. 6 is a flowchart illustrating example methods implemented in a communication system including a host computer, a network node and a WD for receiving user data at a host computer according to some embodiments of the present disclosure;

FIG. 7 is a flowchart of an example process in a WD for radar utilization of communication signals;

FIG. 8 is a flowchart of another example process in a WD for radar utilization of communication signals;

FIG. 9 is a system overview for radar utilization of communication signals in a WD;

FIG. 10 is an illustration of resource elements for radar signal transmission and communication signal transmission; and

FIG. 11 is an example of combining a communication beam and a radar beam, resulting in a combined beam pattern.

### DETAILED DESCRIPTION

Before describing in detail example embodiments, it is noted that the embodiments reside primarily in combinations of apparatus components and processing steps related to radar utilization of communication signals in a wireless device (WD). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3^{rd} party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The generic term “beam” may refer to a main lobe of a directed beam having sidelobes. The term “beam” may refer to a beam pattern having a main lobe and sidelobes. The term “beam” may refer to a beam pattern, generally. A beam pattern may refer to a communication beam pattern, a radar beam pattern or a combined communication and radar beam pattern.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide radar utilization of communication signals in a wireless device (WD).

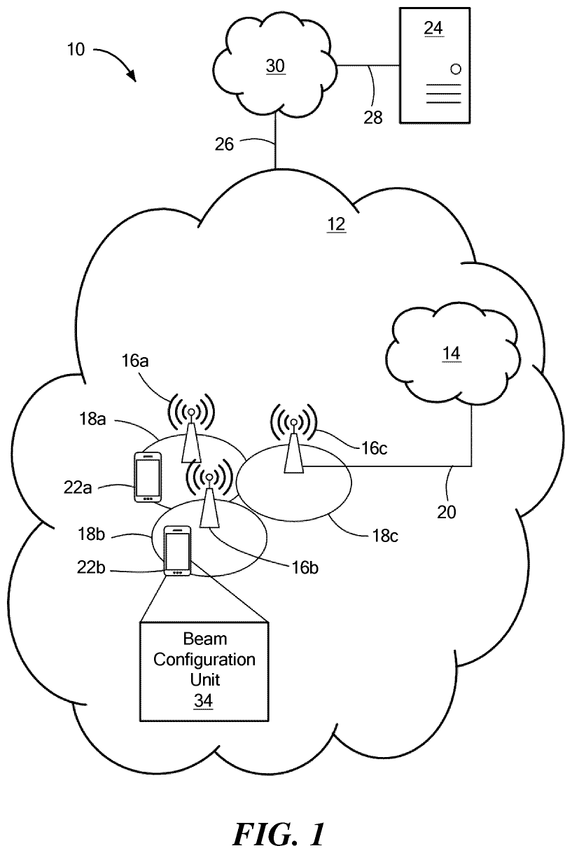

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A wireless device 22 is configured to include a beam configuration unit 34 which is configured to configure a first set of spatial characteristics for a first transmit signal to be transmitted to the network node and to configure a second set of spatial characteristics for a second transmit signal to be transmitted to the network node, the second transmit signal being adapted for communication and radar sensing.

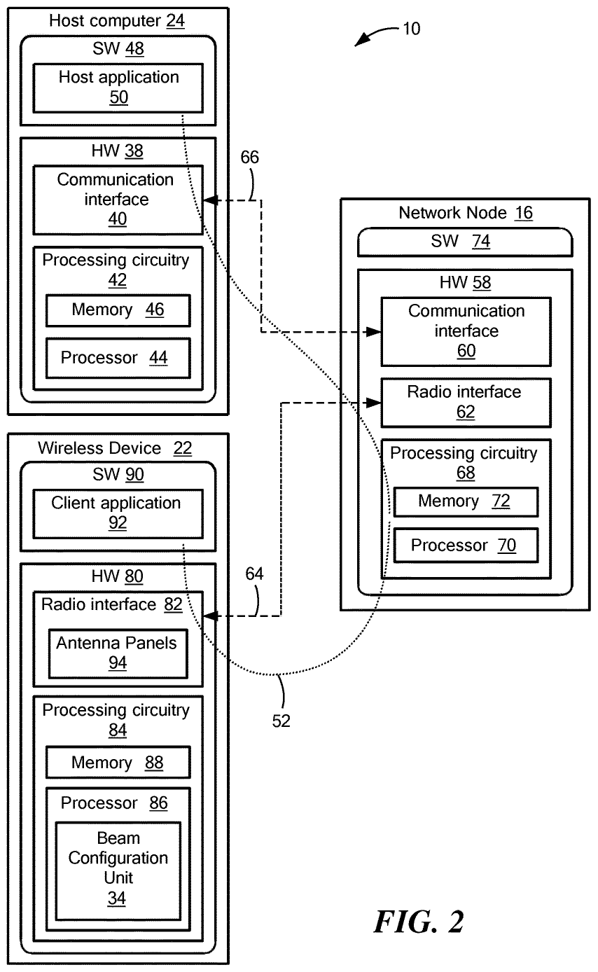

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides. Also, the radio interface 82 may include a plurality of antenna panels 94 configured to separately or jointly form beams having spatial characteristics that may be optimized to facilitate simultaneous communication and radar signaling.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include the beam configuration unit 34 which is configured to configure a first set of spatial characteristics for a first transmit signal to be transmitted to the network node and to configure a second set of spatial characteristics for a second transmit signal to be transmitted to the network node, the second transmit signal being adapted for communication and radar sensing.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

In some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as beam configuration unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

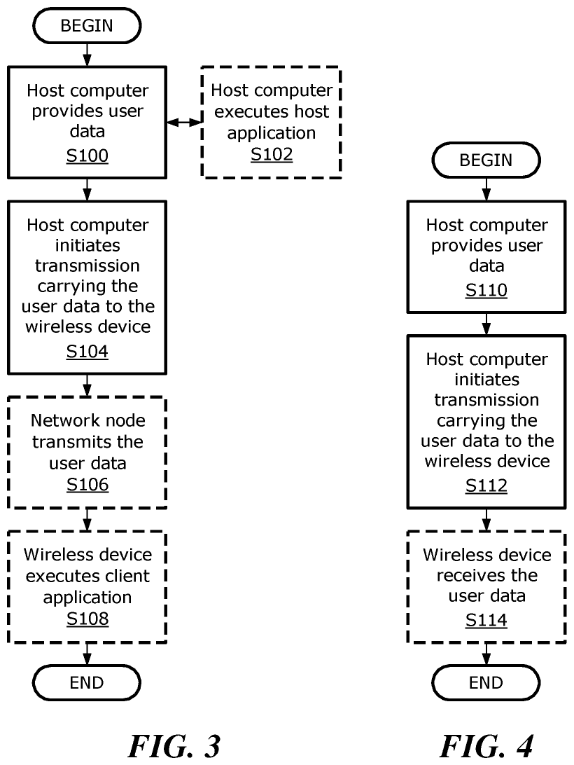

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

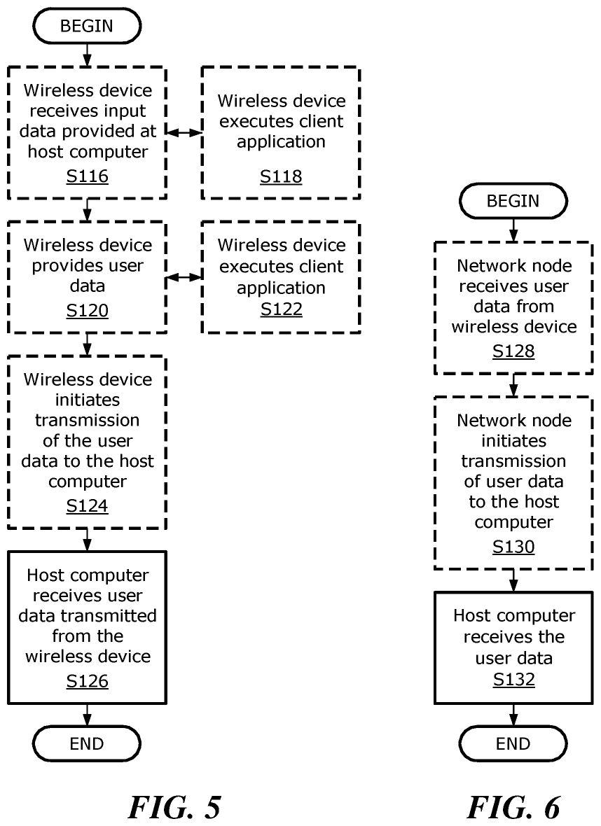

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

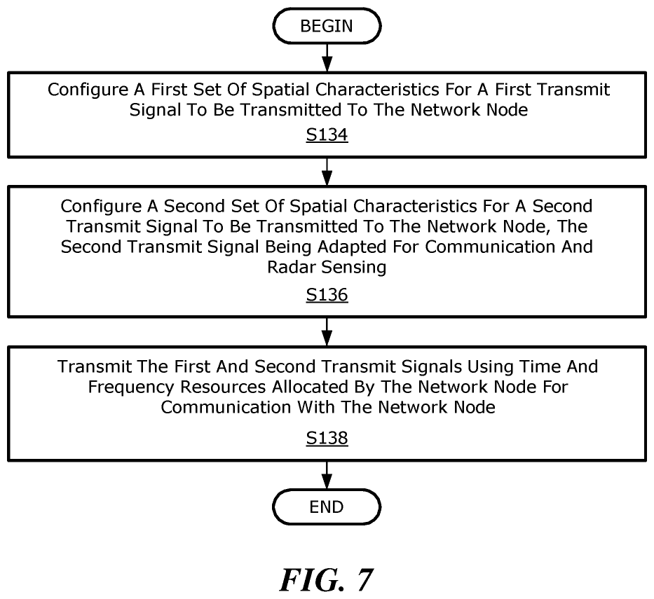

FIG. 7 is a flowchart of an example process in a wireless device 22 according to some embodiments of the present disclosure. One or more blocks described herein may be performed by one or more elements of wireless device 22 such as by one or more of processing circuitry 84 (including the beam configuration unit 34), processor 86, radio interface 82 and/or communication interface 60. Wireless device 22 such as via processing circuitry 84 and/or processor 86 and/or radio interface 82 is configured to configure a first set of spatial characteristics for a first transmit signal to be transmitted to the network node (Block S134). The method includes configuring a second set of spatial characteristics for a second transmit signal to be transmitted to the network node, the second transmit signal being adapted for communication and radar sensing (Block S136). The method also includes transmitting the first and second transmit signals using time and frequency resources allocated by the network node for communication with the network node (Block S138).

According to this aspect, in some embodiments, the method also includes configuring a first subset of the time and frequency resources and a second subset of the time and frequency resources. In some embodiments, the method also includes transmitting to the network node on the first subset, the first transmit signal having the configured first set of spatial characteristics. In some embodiments, the method also includes transmitting to the network node on the second subset, the second transmit signal having the configured second set of spatial characteristics. In some embodiments, the method also includes modifying spatial characteristics of the second set of spatial characteristics to configure the second transmit signal for radar sensing. In some embodiments, spatial characteristics of the first set of spatial characteristics are determined prior to transmission of a sounding reference signal, SRS, and maintained until a next SRS transmission. In some embodiments, the method also includes modifying the second set of spatial characteristics while maintaining a communication beam with the first set of spatial characteristics during a sounding reference signal, SRS, period. In some embodiments, the first set of spatial characteristics are selected to provide a main lobe for communication signaling and the second set of spatial characteristics are selected to provide a side lobe for radar sensing using the communication signaling. In some embodiments, the method also includes transmitting the first transmit signal according to the first set of spatial characteristics and includes a second antenna set configured to transmit the second transmit signal according to the second set of spatial characteristics. In some embodiments, the method includes transmitting both the first transmit signal and the second transmit signal from a same antenna set. In some embodiments, the second set of spatial characteristics include a first set of beamforming weights for forming a radar beam and the first set of spatial characteristics include a second set of beam forming weights for forming a communication beam. In some embodiments, the method includes adding the first set of beamforming weights and the second set of beam forming weights to produce a beam pattern for transmitting a radar signal on the radar beam and a communication signal on the communication beam, wherein the radar signal and the communication signal are the same transmission signal. In some embodiments, the radar beam and the communication beam are formed using a same set of time-frequency resources.

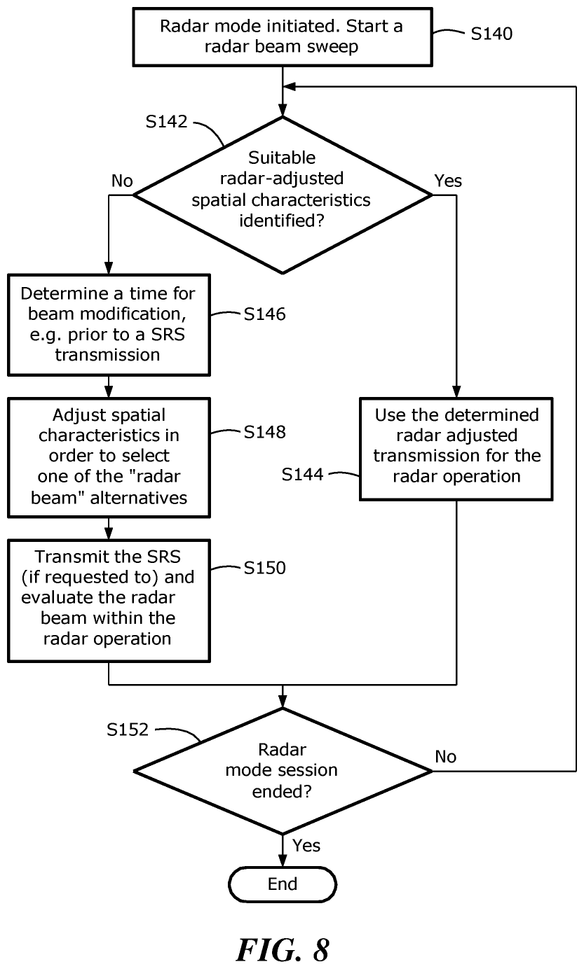

FIG. 8 is a flowchart of an example process in a wireless device 22 according to some embodiments of the present disclosure. One or more blocks described herein may be performed by one or more elements of wireless device 22 such as by one or more of processing circuitry 84 (including the beam configuration unit 34), processor 86, radio interface 82 and/or communication interface 60. The process performed by the wireless device 22, processing circuitry 84, radio interface 82 and/or communication interface 80 may include initiating a radar mode and starting a beam sweep operation (S140). The example process of FIG. 8 enables the WD 22 to search for suitable radar adjustment of its transmit beam during an ongoing communication with the network. The WD may determine a need to adjust its transmit spatial characteristics to also perform radar operation, and switch between different options of such adjustment. Such adjustment may in one or more examples be performed in-between SRS cycles in the communication with the network. In this manner the network may perform analysis such as channel sensing on signals transmitted by the WD having the same transmit characteristics from the device as the communication, while the device may adjust its transmit characteristics for coming SRS transmissions.

The process of FIG. 8 includes determining whether acceptable radar-adjusted spatial characteristics have been identified (Block S142). If acceptable radar-adjusted spatial characteristics have been identified, then the identified acceptable radar-adjusted spatial characteristics are used for transmission for radar operation (Block S144). On the other hand, if acceptable radar-adjusted spatial characteristics have not been identified, a time for beam modification is determined (Block S146). Methods to determine whether acceptable radar-adjusted spatial characteristics have been identified are disclosed herein. Some methods may be performed by communication with one or more other wireless devices, such as by receiving one or more indicators of the radar sensing performance or detected signal strength from a different wireless device. Such communication may be performed by, for example, utilizing a communication protocol other than the cellular technology protocol, e.g., local connectivity communication between devices via Bluetooth, IEEE 802.11 or other local or short range communication. In one or more examples, the determining may be performed by the WD itself, e.g., by analyzing one or more transmit or receive characteristics, such as energy transmitted in a certain direction relative to the device movement.

For example, the determined time for beam modification may be prior to a sounding reference signal (SRS) transmission. The spatial characteristics of the beam may be adjusted in order to select one of a set of radar beam alternatives (Block S148). The SRS may be transmitted and the radar beam may be evaluated for radar operation (Block S150). The process then proceeds to Block S152 to determine if radar mode has ended. If not, the process proceeds to Block S142. If the radar mode has ended, the process ends.

Some embodiments include a WD which is configured to communicate control signaling and/or data in a wireless communication network on assigned transmit resources for the uplink and/or sidelink transmissions of the WD. Upon determining an opportunity to utilize its expected transmissions for a radar sensing operation, the WD may temporarily adjust its spatial transmit characteristics, so that energy from the control and/or data transmissions for uplink and/or sidelink communication by the WD may also be utilized for radar sensing in a better manner than it would without the adjusted spatial characteristics. This may include temporarily adding transmit energy via a side lobe from the transmitter chain in a direction suitable for the radar sensing, when performing the control and/or data communications with the wireless network. In this manner, the radar sensing operation may occur by using the transmit signals generated as they are expected to be generated according to the communication protocol with the wireless network. Using one or more of these signals and/or channels generated for the purpose of communication with the wireless network over the uplink and/or sidelink, the use of the transmissions for radar sensing in addition to communication may be performed without specific configuration or extra control signaling by the network.

In other words, the first and second transmit signals may both be signals expected by the network node to be transmitted by the WD, and constructed as specified by the communication protocol used in the communication with the network node. For example, the first and second transmit signals may be two control signals of the same type, which are transmitted by the WD at different times. Or they may be data transmission occasions where the WD is transmitting payload data to the network or to another WD. For example, the first and second transmit signals may be two occasions of SRS transmissions, two occasions of random access preamble transmissions, two occasions of PRS transmissions, two occasions of sidelink synch signals, or of any data and/or control channels or signals to be transmitted by the WD according to the utilized communication protocol. Adapting the second transmit signal to additionally be used for radar signaling may include the WD serving a dual purpose (both communication and radar) with the transmission of the second transmit signal. Meanwhile, there may be no change to channel coding, data generation, signal generation, modulation or other protocol or signal generation modification of the second transmit signal. This is in comparison to the first transmit signal. The only change may be change of utilized spatial characteristics. Hence, the second set of spatial characteristics may be used by the WD for transmissions when the WD determines a usage of an upcoming transmission for radar sensing in addition to the communication purpose, wherein the second set of transmit spatial characteristics support additional use for radar sensing. In other words, the adaption of a transmit signal to additionally be used for radar signaling may be performed by applying different spatial transmit characteristics to, for example, create a side lobe of transmit energy in a direction targeted for radar sensing when transmitting a signal.

The WD may be configured to modify the second set of spatial characteristics to configure the second transmit signal for radar sensing. For example, the WD may apply different spatial transmit characteristics resulting in a different angular output power transmit pattern when transmitting the second transmit signal in comparison to when the WD transmits the first transmit signal. In this case, the emitted energy may be more suitable for use of the transmission for both the intended communication and for radar sensing. Still, as described above, the first and second transmit signals may be the same type of signals with the same information and the same signal properties. Signal properties may include modulation, coding, sequence generation or any properties of the radio protocol layers impacting the signal. In other words, the second transmit signal may be formed by adding transmit energy in a different direction from the WD when performing the transmission of the second signal compared to when performing the transmission of the first signal. This may be done in such a way that more energy is transmitted in a side lobe direction compared to the energy transmission of the first signal. The WD may have a dual-purpose for the transmission: to utilize the known upcoming transmission of the second signal for radar sensing and communication. Configuring the second transmit signal may include configuring the WD to use the second transmit signal for combined communication and radar sensing. In some embodiments, configuring the second transmit signal may imply that the signal generation in all other beans in different transmit directions from the WD is the same for the first and second transmission.

Further, the WD may be configured to configure a first subset of the time and frequency resources and a second subset of the time and frequency resources. This may include configuring the WD to identify a first subset of the network allocated time and frequency resources which are suitable to use for a communication purpose only. The WD may be configured to also identify a second subset of the network allocated time and frequency resources which are suitable to use for combined communication and radar sensing. Further, the WD may apply the first set of spatial transmit characteristics on an upcoming transmission on the first subset of resources and it may apply the second set of spatial transmit characteristics on an upcoming transmission on the second subset of resources. In this manner, the transmission on the second subset of resources may, for example, require more energy to be transmitted in a side lobe direction compared to the transmission on the first subset of resources. And the reflected RF signal from this additional energy can be used for radar sensing by the WD or by another WD within proximity of the WD.

Having described the general process flow of arrangements of the disclosure and having provided examples of hardware and software arrangements for implementing the processes and functions of the disclosure, the sections below provide details and examples of arrangements for radar utilization of communication signals in a wireless device (WD).

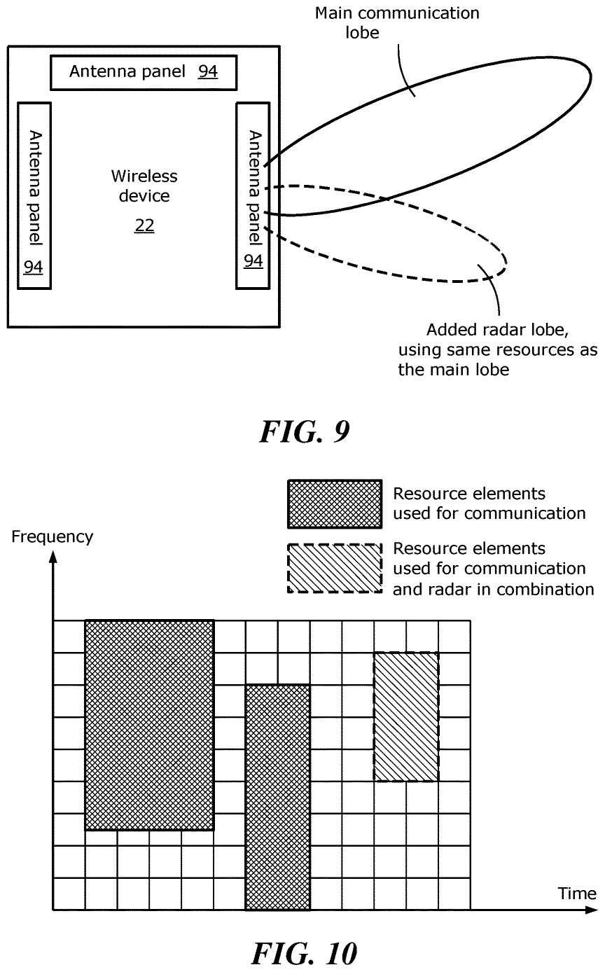

An illustration of a high-level overview of the scenario for this proposal is shown in FIG. 9. A basic assumption of the example of FIG. 9 is that a WD 22 operates as a communication device in a cellular wireless system and may simultaneously be configured to perform a radar/sensing operation. The network node that assigns communication resource may not be aware of the simultaneous radar configuration of the WD 22. In other words, one or more radio resource elements may be shared to be used both for communication with another entity in the network as well as also used for radar functionality. An example of such resource allocation sharing is illustrated in FIG. 10

In some embodiments, a WD 22 may modify one or more spatial transmission characteristics of the signal when transmitting on combined resources to form a different beam pattern for improved radar functionality.

In some embodiments, the modification is made during a certain period of time, when the WD 22 is engaged in radar operation. In some embodiments, the WD 22 may be engaged in a radar operation session, which in turn may be initiated in several different ways. Such radar function initiation may be done be at least one or more of the following:
User initiation by via a user interface which triggers the WD 22 to start operating a radar function. This may initiate a WD 22 coordination function where multiple WDs within proximity may be identified as being suitable WDs to support a bistatic or multistatic radar operation. Such coordination could be done via separate communication links such as Wi-Fi or Bluetooth local connectivity or WD 22 to WD 22 (side link) communication over the cellular connectivity;
Initiation by another WD 22 asking it to perform radar operation, similar to the alternative above; and/or
Network node initiation of radar operation involving the WD 22 via the signaling protocol used between the WD 22 and the cellular network.

The WD 22 may extract the desired radar signal transmission beam power and direction from the above radar function initiation. Once the WD 22 has determined that the radar operation is soon to be executed, the WD 22 may start to adjust its spatial characteristics for the expected radar operation. For example, the desired radar illumination direction and over the air synchronization reference path (for bi-static radar operation) between transmit (TX) and (RX) node. In some embodiments, the network node 16 may assume beam correspondence functionality to be valid for the WD 22, meaning that independent of the adjustment of the spatial characteristics, the main lobe should be maintained in order to ensure that the WD 22 is capable of determining its best transmit beam for communication using the receive beam characteristics independent of any adjustments of the side lobes for the radar operation.

Further, the WD 22 may be granted sounding reference signal (SRS) transmissions or may be granted other transmissions which may be used to maintain a good communication link evaluation between the WD 22 and the network in the uplink.

In some embodiments, the WD 22 may adjust the spatial characteristics of a beam, e.g., prior to a SRS transmission and thereafter keep the same spatial characteristics until the next SRS transmission. In this manner, the WD 22 may perform a radar beam sweep over multiple SRS transmission cycles, while at the same time maintaining the transmit characteristics from SRS transmission to data transmission for each SRS cycle. In this manner, the network node 16 may evaluate the full transmission property of the WD 22 for each SRS transmission and reliably estimate the communication contribution of the radar lobe configured according to a subset of spatial characteristics of beams for communication and radar signaling. The network node 16 may estimate and account for possible interference impact of the radar lobe to other transmission and reception points (TRPs) or cells.

In some embodiments, the WD 22 may over time perform multiple different spatial transmissions during a single SRS cycle. If the SRS sounding procedure is infrequent, the WD 22 may perform radar sensing in multiple directions between two SRS transmissions. In this manner, the WD 22 may modify the transmissions over time to ensure that different side lobes for radar beams may be used while still maintaining the same main lobe for communication transmission purposes. In an alternative embodiment, the WD 22 may thus perform the communication-related transmission (e.g., the SRS sounding transmission) that the network node 16 uses to determine the channel conditions and possible link adaptation using only the second, dedicated communication lobe (the second subset of spatial characteristics) while the radar lobe is deactivated. Then, the network node 16 need not rely on any energy contained in the radar lobe and the communication transmission is robust for any radar transmission direction.

### Example Methods of Spatial Transmission Modification

A WD 22 may perform a modification of its spatial characteristics in multiple ways while maintaining fulfilment of radio requirements.

In some embodiments, a WD 22 may be modified for radar optimization using multiple antenna panels 94 for the same transmission. In this manner, the WD 22 may transmit a main beam from a first antenna panel 94 and in addition add a second radar-optimized beam transmitted by a second antenna panel 94.

In some embodiments, the WD 22 may be configured to combine a communication beam and a radar beam for transmission from the same antenna panel 94. For each of the two beams, the beam/precoding weights may be determined separately. For the communication lobe (which may be the main beam or a lobe having a desired signal power in a beam direction for communication signaling), the precoding coefficients may be determined according to legacy algorithms, based on previous received signals or measurements and/or based on configuration information from the network node 16. For the radar lobe, the lobe direction and configuration may be determined based on the desired illumination area/direction with respect to the WD 22 position and orientation. The weights to form the radar lobe may be based on the predetermined location and radiation patterns of WD 22 antenna elements. The position and orientation may be based on previous sensing and/or positioning information, input from an inertial motion unit (IMU), etc.

A desired direction may be determined based on objects detected in previously sensed or imaged areas, for example, to perform higher-resolution scanning of part of an area or for spatial regions remaining to be sensed, for example, to complete the scan of an environment, etc. For each antenna element, the corresponding weights for the two beams may be added to obtain the weight for the combined transmission pattern. In a beamformer with cartesian antenna element weights, for instance a digital beamformer, the I and Q coordinates are added separately. In a beamformer with polar antenna element weights, for instance an analog beamformer, the amplitude and phase of the added vectors must be calculated. For instance, this may be obtained by converting both weights to cartesian coordinates, I and Q, which may then be added separately, and the result is then converted back to polar coordinates. Without quantization, the result may be a perfect summation of the two beam patterns. However, analog beamformers with polar weights tend to have significant quantization of amplitude and phase weights, which may affect the result. For this reason, a simulation was performed to investigate the effect of quantization when adding a lower power radar beam to the main communication beam.

### Example Simulation of a Beam Modification

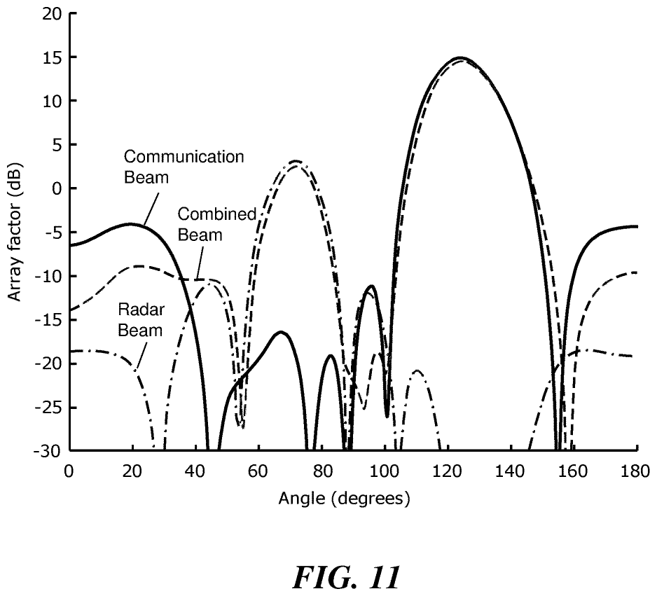

FIG. 11 shows an example MATLAB simulation to illustrate the beamforming effect when using antenna weights in the form of amplitude and phase when adding a strong beam pattern with a weaker beam pattern, when all phase and amplitude weights are quantized. In the example of FIG. 11, the stronger pattern is the angular power spectrum of communication transmission (the communication beam) and the weaker pattern is the angular power spectrum of radar transmission (the radar beam). The quantized amplitude and phase are common in analog beamforming circuitry.

In FIG. 11, the combined beam pattern follows the two main lobes very well. All amplitudes are quantized in 10 equally spaced levels, and the phases in 10 degree steps. In other words, the array patterns may be successfully added with reasonable quantization requirements.

For the simulation results of FIG. 11 the amplitude of the summation of the two array patterns was clipped to the maximum value for antenna element weights where the maximum would otherwise have been exceeded, rather than reducing the entire array amplitude to fit all amplitude weights inside the range. Even though such clipping has been performed, the summation pattern follows the two main lobes well.

FIG. 11 is a simulation for a linear array with 8 antenna elements with one-wavelength spacing. The angle 90 degrees on the x-axis in FIG. 3 corresponds to boresight.

As disclosed above, in some embodiments, the radar lobe and the communication lobe may have signal contents in common time and frequency resource elements. In some embodiments, the radar lobe contents may be different from the communication lobe contents, To improve ranging performance, the radar lobe signal may be a different sequence with auto-or cross-correlation properties, or a shorter signal occupying only a part of the assigned symbol(s) to reduce full-duplex leakage, etc. Some embodiments may be employed in cases where the radar lobe direction may not contribute to the signal received by the network node 16 (e.g., the WD 22 is in line of sight (LOS) and/or the radar lobe is directed away from the direction toward the network node 16). Any prior signaling used by the network node 16 to configure WD 22 transmissions, e.g., preparatory UL sensing or DL RS reception and evaluation and application of beam correspondence, may then be performed with only the communication lobe active and the radar lobe inactive.

Some embodiments may include one or more of the following:
Embodiment 1. Method in a WD 22 for radar signal transmission, comprising:
configuring a first transmission lobe for radar signal transmission,
configuring a second transmission lobe for communication signal transmission,
transmitting simultaneously the first and second lobes.
Embodiment 2. The method of Embodiment 1, wherein the first and second lobes contain a second [communication] signal.
Embodiment 3. The method of Embodiment 1, wherein the first lobe contains a first [radar] signal and the second lobe contains a second [communication] signal.
Embodiment 4. The method of Embodiment 2, wherein the first and second lobes are transmitted by summing the first and second lobe precoding/beamforming weights on two or more antenna elements of a first antenna panel.
Embodiment 5. The method of Embodiment 2, wherein the first and second lobes are transmitted by applying the first lobe precoding/beamforming weights on a first antenna panel and applying the second lobe precoding/beamforming weights on a second antenna panel.
Embodiment 6. The method of Embodiment 1, wherein the first lobe precoding/beamforming weights are configured based on the desired radar scanning direction relative to the WD 22 and the second lobe precoding/beamforming weights are configured based on optimizing communication signal transmission [legacy].
Embodiment 7. The method of Embodiment 1, further comprising performing preparatory signal reception/transmission to allow the NW schedule/configure communication transmissions (1) with only the second lobe activated, or (2) with the first and second lobes activated. As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3^{rd} generation partnership project
DL Downlink
eNB evolved node B
gNB next generation node B
SRS Sounding Reference Signal
LTE Long Term Evolution
NR New Radio
UL Uplink
WD Wireless Device

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device, WD, configured to communicate with a network node the WD comprising:
processing circuitry configured to:
configure a first set of spatial characteristics for a first transmit signal to be transmitted to the network node;
configure a second set of spatial characteristics for a second transmit signal to be transmitted to the network node, the second transmit signal being adapted for communication and radar sensing; and
a radio interface in communication with the processing circuitry and configured to transmit the first and second transmit signals using time and frequency resources allocated by the network node for communication with the network node.

2. The WD of claim 1, wherein:
the processing circuitry is further configured to configure a first subset of the time and frequency resources and a second subset of the time and frequency resources; and
the radio interface is further configured to:
transmit to the network node on the first subset, the first transmit signal having the configured first set of spatial characteristics; and
transmit to the network node on the second subset, the second transmit signal having the configured second set of spatial characteristics.

3. The WD of claim 1, wherein the processing circuitry is further configured to modify spatial characteristics of the second set of spatial characteristics to configure the second transmit signal for radar sensing.

4. The WD of claim 1, wherein spatial characteristics of the second set of spatial characteristics are determined prior to transmission of a sounding reference signal, SRS, and maintained until a next SRS transmission.

5. The WD of claim 1, wherein the processing circuitry is further configured to modify the second set of spatial characteristics while maintaining a communication beam with the first set of spatial characteristics during a sounding reference signal, SRS, period.

6. The WD of claim 1, wherein the first set of spatial characteristics are selected to provide a main lobe for communication signaling and the second set of spatial characteristics are selected to additionally provide a side lobe for radar sensing using the communication signaling.

7. The WD of claim 1, wherein the radio interface includes a first antenna set configured to transmit the first transmit signal according to the first set of spatial characteristics and includes a second antenna set configured to transmit the second transmit signal according to the second set of spatial characteristics.

8. The WD of claim 1, wherein the radio interface is configured to transmit both the first transmit signal and the second transmit signal from a same antenna set.

9. The WD of claim 1, wherein the second set of spatial characteristics include a first set of beam forming weights for forming a radar beam and the first set of spatial characteristics include a second set of beam forming weights for forming a communication beam.

10. The WD of claim 9, wherein the processing circuitry is further configured to add the first set of beam forming weights and the second set of beam forming weights to produce a beam pattern for transmitting a radar signal on the radar beam and a communication signal on the communication beam, and wherein the radar signal and the communication signal are the same transmission signal.

11. The WD of claim 9, wherein the radar beam and the communication beam are transmitted using a same set of time-frequency resources.

12. A method in wireless device, WD configured to communicate with a network node, the method comprising:
configuring a first set of spatial characteristics for a first transmit signal to be transmitted to the network node;
configuring a second set of spatial characteristics for a second transmit signal to be transmitted to the network node, the second transmit signal being adapted for communication and radar sensing; and
transmitting the first and second transmit signals using time and frequency resources allocated by the network node for communication with the network node.

13. The method of claim 12, further comprising:
configuring a first subset of the time and frequency resources and a second subset of the time and frequency resources;
transmitting to the network node on the first subset, the first transmit signal having the configured first set of spatial characteristics; and
transmitting to the network node on the second subset, the second transmit signal having the configured second set of spatial characteristics.

14. The method of claim 12, further comprising modifying spatial characteristics of the second set of spatial characteristics to configure the second transmit signal for radar sensing.

15. The method of claim 12, wherein spatial characteristics of the first set of spatial characteristics are determined prior to transmission of a sounding reference signal, SRS, and maintained until a next SRS transmission.

16. The method of claim 12, further comprising modifying the second set of spatial characteristics while maintaining a communication beam with the first set of spatial characteristics during a sounding reference signal, SRS, period.

17. The method of claim 12, wherein the first set of spatial characteristics are selected to provide a main lobe for communication signaling and a the second set of spatial characteristics are selected to provide a side lobe for radar sensing using the communication signaling.

18. The method of claim 12, further comprising transmitting the first transmit signal according to the first set of spatial characteristics and includes a second antenna set configured to transmit the second transmit signal according to the second set of spatial characteristics.

19. The method of claim 12, further comprising transmitting both the first transmit signal and the second transmit signal from a same antenna set.

20. The method of claim 12, wherein the second set of spatial characteristics include a first set of beam forming weights for forming a radar beam and the first set of spatial characteristics include a second set of beam forming weights for forming a communication beam.

21. The method of claim 20, further comprising adding the first set of beam forming weights and the second set of beam forming weights to produce a beam pattern for transmitting a radar signal on the radar beam and a communication signal on the communication beam, and wherein the radar signal and the communication signal are the same transmission signal.

22. The method of claim 20, wherein the radar beam and the communication beam are transmitted using a same set of time-frequency resources.
